(19) United States
(12) Patent Application Publication
(10) Pub. No.: US 2011/0296198 A1
(43) Pub. Date: Dec. 1, 2011

(54) CRYPTOGRAPHIC PROCESSING APPARATUS AND IC CARD

(75) Inventor: Masahiko Motoyama, Kanagawa (JP)

(73) Assignee: KABUSHIKI KAISHA TOSHIBA, Tokyo (JP)

(21) Appl. No.: 13/033,671

(22) Filed: Feb. 24, 2011

(30) Foreign Application Priority Data
May 27, 2010 (JP) 2010-121842

(51) Int. Cl. H04L 9/00

(52) U.S. Cl. 713/189

(57) ABSTRACT

A cryptographic processing apparatus according to embodiments includes a cryptographic operation processing section that can execute cryptographic processor of encryption operation and decryption operation, and a control section. The control section controls the execution of the cryptographic operation processing section such that a first operation for converting a first value, which is input data to be subjected to cryptographic processor, or intermediate data during cryptographic processor, into a second value, and a second operation for converting the second value into the first value are performed successively at least one time.

### CROSS-REFERENCE TO RELATED APPLICATION

This application is based upon and claims the benefit of priority from the Japanese Patent Application No. 2020-121842 filed in Japan on May 27, 2010; the entire contents of which are incorporated herein by reference.

### FIELD

Embodiments described herein relate generally to a cryptographic processing apparatus and an IC card.

### BACKGROUND

Conventionally, there is a method called a power analysis for extracting confidential information that is used in a cryptographic processing apparatus from the power consumed in the cryptographic processing apparatus. A countermeasure against such an analysis method is, for example, a technique to insert dummy DES (Data Encryption Standard) operation during DES operation. This technique provides a cryptographic processing apparatus with resistance against power analysis by inserting dummy operation processing.

However, in a cryptographic processing apparatus, a register circuit for retaining data or a dummy key for dummy operation will be required in order to execute dummy operation processing during operation. Moreover, because the content of the register that saves regular intermediate result does not change in a dummy operation cycle, power consumption thereof tends to be smaller than other cycles. Thus, if a cycle is identified as a dummy operation cycle from such tendency, effects of the insertion of dummy operation processing will be negated. Therefore, there is a need for development of a cryptographic processing apparatus having enhanced resistance against power analysis attacks besides those based on insertion of dummy operation processing.

### BRIEF DESCRIPTION OF THE DRAWINGS

FIG. 1 is a configuration diagram to show the configuration of a cryptographic processing apparatus 1 relating to a first embodiment;

FIG. 2 is a block diagram to show the configuration of a cryptographic circuit module 15 relating to the first embodiment;

FIGS. 3A and 3B are timing charts to show the processing status in a case in which conventional dummy processing is not included;

FIGS. 4A and 4B are timing charts to show the processing status in a case in which conventional dummy processing is included;

FIGS. 5A and 5B are timing charts to show the processing status in a case in which reverse operation processing of the first embodiment is used;

FIG. 6 is a graph to show an example of the temporal change of the step of cryptographic processor of the first embodiment;

FIG. 7 is a configuration diagram to show the configuration of a cryptographic processing apparatus 1A relating to a second embodiment;

FIG. 8 is a flowchart to show an example of processing flow when a CPU 11 determines and executes execution steps of cryptographic processor based on a random number RN, relating to the second embodiment;

FIG. 9 is a configuration diagram to show the configuration of a cryptographic processing apparatus 1B relating to a third embodiment;

FIG. 10 is a block diagram to show the configuration of a cryptographic circuit module 15B relating to the third embodiment;

FIG. 11 is a diagram to illustrate the timing at which a comparator 42 relating to the third embodiment makes comparison;

FIG. 12 is a block diagram to show the configuration of a cryptographic circuit module 15C of a cryptographic processing apparatus of a fourth embodiment;

FIG. 13 is a diagram to show an algorithm of DES of the fourth embodiment;

FIG. 14 is a diagram to show an example in which reverse operation is inserted into encryption operation, showing a part of the algorithm of DES of the fourth embodiment;

FIG. 15 is a diagram to show the processing flow from S1 to S7 of FIG. 14;

FIG. 16 is a diagram to illustrate the operation of a first variation;

FIG. 17 is a diagram to show a first example of the change of the probability of execution of cryptographic processor based on a probability adjustment signal Pc from a probability adjustment section 18a relating to a second variation;

FIG. 18 is a diagram to show a second example of the change of the probability of execution of cryptographic processor based on the probability adjustment signal Pc from the probability adjustment section 18a relating to the second variation;

FIG. 19 is a diagram to show a third example of the change of the probability of execution of cryptographic processor based on the probability adjustment signal Pc from the probability adjustment section 18a relating to the second variation;

FIG. 20 is a diagram to show the configuration of a cryptographic processing apparatus 1D relating to the second variation; and

FIG. 21 is a graph to show an example of the change of step with respect to time in the case relating to a third variation in which reverse operation processing and dummy operation processing are combined.

### DETAILED DESCRIPTION

A cryptographic processing apparatus according to embodiments includes: a cryptographic operation processing section that can execute cryptographic processor of encryption operation and decryption operation; and a control section. The control section controls the execution of the cryptographic operation processing section such that a first operation for converting a first value, which is input data to be subjected to cryptographic processor, or intermediate data during cryptographic processor, into a second value, and a second operation for converting the second value into the first value are performed successively at least one time.

Hereafter, embodiments are described with reference to the drawings.

### First Embodiment

### [Configuration]

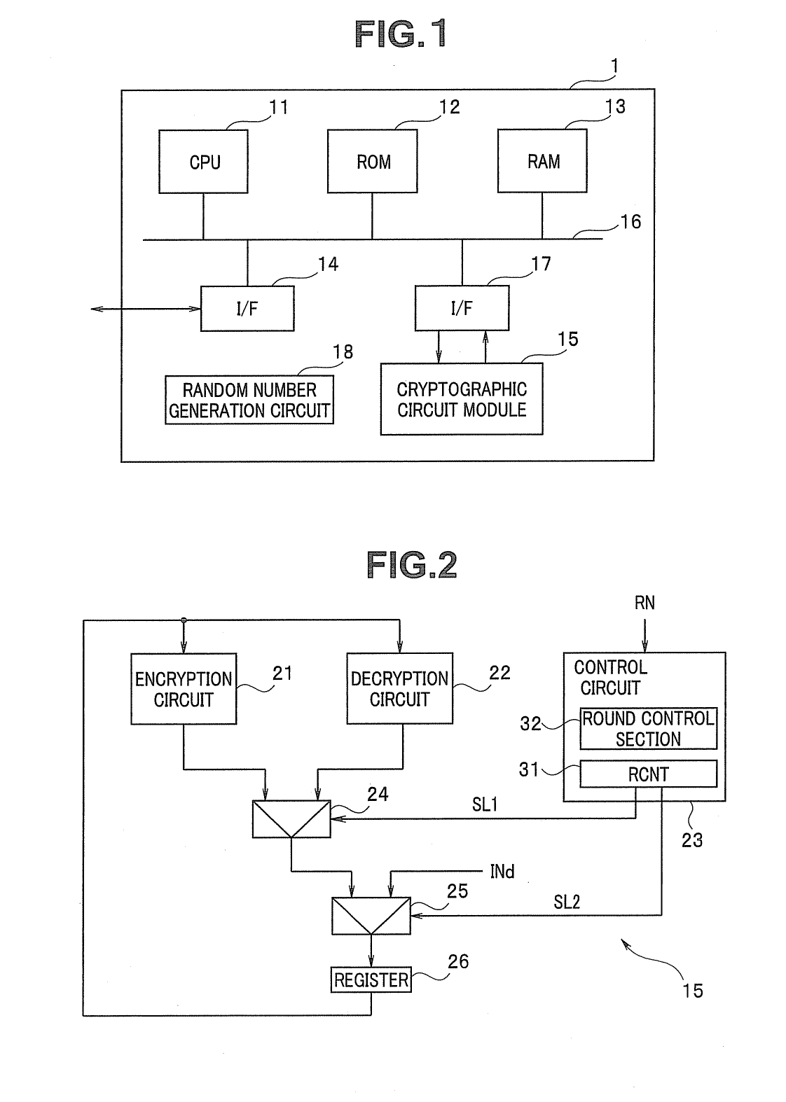

First, based on FIG. 1, the configuration of a cryptographic processing apparatus to be equipped with a cryptographic processing circuit relating to the present embodiment will be described. FIG. 1 is a configuration diagram to show the configuration of a cryptographic processing apparatus 1 relating to the present embodiment.

The cryptographic processing apparatus 1 is configured to include: a central processing unit (CPU) 11; a ROM 12 that stores programs and so on; a RAM 13 as working storage area for the CPU 11; a transmission/reception interface circuit (hereafter, abbreviated as a transmission/reception I/F) 14 for transmitting/receiving data to and from the outside; a cryptographic circuit module 15 including a cryptographic processing circuit; a cryptographic circuit I/F 17 between the cryptographic circuit module 15 and a bus 16; and a random number generation circuit 18 which is a circuit for generating random numbers. The CPU 11, the ROM 12, the RAM 13, the transmission/reception I/F 14, and the cryptographic circuit I/F 17 are connected to each other via the bus 16.

The cryptographic processing apparatus 1, which is, for example, an IC (Integrated Circuit) card, subjects data from an external apparatus (not shown), such as a card reader apparatus and so on, to predetermined cryptographic processor upon receiving the data, and outputs or transmits the result data of the cryptographic processor. The cryptographic processor refers to encryption operation or decryption operation. The transmission/reception of data to and from an external apparatus is performed through the transmission/reception I/F 14 and, for example, through wireless communication via a circuit (not shown) for wireless communication.

Moreover, the data transmitted/received between the CPU 11 and the cryptographic circuit module 15 is also encrypted.

The cryptographic circuit module 15 includes two cryptographic operation circuits and executes encryption operation and/or decryption operation. The cryptographic operation circuit of the present embodiment is a circuit that utilizes a round function of AES (Advanced Encryption Standard). The round function of AES receives data input, as well as input of a round key (extended key), which is inputted in each round, as key data.

The random number generation circuit 18 is a circuit for generating and outputting random numbers.

FIG. 2 is a block diagram to show the configuration of the cryptographic circuit module 15. The cryptographic circuit module 15 is a cryptographic processing apparatus that includes an encryption circuit 21, a decryption circuit 22, a control circuit 23, selectors 24 and 25, and a register 26.

The encryption circuit 21 is a circuit for executing encryption operation of predetermined AES on the input data, and the decryption circuit 22 is a circuit for executing decryption operation of the predetermined AES on the input data. The encryption circuit 21 and the decryption circuit 22 make up a cryptographic operation processing section that can execute cryptographic processor of encryption operation and decryption operation.

In the case of encryption operation, the encryption circuit 21 operates a predetermined number of times, for example, 11 times. In the case of decryption operation, the decryption circuit 22 operates a predetermined number of times. The decryption operation by the decryption circuit 22 corresponds to a reverse operation of the encryption operation by the encryption circuit 21. The encryption operation by the encryption circuit 21 corresponds to a reverse operation of the decryption operation by the decryption circuit 22. Note that confidential information used for cryptographic processor, such as key data and so on, is stored in a non-volatile memory not shown.

The control circuit 23 is a control section that controls the encryption circuit 21 and the decryption circuit 22. The control circuit 23 receives input of a signal instructing which of encryption and decryption is to be performed; and based on the instruction, the control circuit 23 causes the encryption circuit 21 and the decryption circuit 22 to execute encryption operation or decryption operation. The control circuit 23 provides a selection signal SL1 instructing which of the output signal of the encryption circuit 21 and the output signal of the decryption circuit 22 is to be used, to the selector 24. The control circuit 23 provides a selection signal SL2 instructing whether or not an initial value INd is to be used, to the selector 25.

The two output signals of the encryption circuit 21 and the decryption circuit 22 are inputted to the selector 24. The selector 24 selects and outputs one of the two output signals that have been inputted, according to the control signal, that is, the selection signal SL1, from the control circuit 23. For example, when encryption operation is performed, the control circuit 23 selects the output of the encryption circuit 21.

The output signal of the selector 24 is inputted to one input end of the selector 25. The initial value INd is inputted to the other input end of the selector 25. The initial value INd is a plain text to be encrypted, or a cryptogram to be decrypted. The selector 25 selects and outputs the initial value INd only when processing for the initial value INd of cryptographic processor is performed.

The output of the selector 25 is provided to the register 26 and is retained therein. The data to be retained in the register 26 is provided to the encryption circuit 21 and the decryption circuit 22 as input data.

The initial value INd, which has been inputted via the I/F 17, is first held in the register 26 and thereafter will not be selected at the selector 25 when encryption operation or decryption operation is started. When encryption operation or decryption operation is started, the selector 25 selects the output of the selector 24, and outputs result data of the encryption operation or the decryption operation. Therefore, data held in register 26 is intermediate data of the encryption operation or the decryption operation, or result data that is finally encrypted or decrypted. The result data of the register 26 is outputted from the cryptographic circuit module 15 as output data to the bus 16 via the OF 17, and can be processed by the CPU 11.

The control circuit 23 includes a round control counter 31 and a round control section 32. The control circuit 23 further receives input of a random number RN from the random number generation circuit 18 which is a random number generation section.

The round control counter 31 is a circuit for counting the number of the round to be executed next. For example, a round number in accordance with the step of cryptographic processor is set in the round control counter 31.

The round control section 32 is a circuit that performs the control to change the value of the round control counter 31 according to a random number RN. That is, the round control section 32 determines one or more positions in the processing cycle for inserting reverse operation and normal operation corresponding to the reverse operation, and the number of the steps of reverse operation (and normal operation corresponding to the reverse operation) to be inserted according to a value of a random number RN that has been inputted, and changes the value of the round control counter 31.

In general, in the case of AES, the counter value corresponding to steps S1 to S11 is incremented by one in the round control counter 31. To be specific, the round control section 32 controls the round control counter 31 such that the counter value of the round control counter 31 is changed in such a way as 1, 2, 3, 4, 5, 6, 7, 8, 9, 10, and 11.

However, in the case of the present embodiment, the round control section 32 increases or decreases the round control counter 31 based on the one or more positions and number of steps which are determined based on the random number RN that has been inputted. For example, the round control section 32 changes the counter value of the round control counter 31 in such a way as 1, 2, 3, 2, 3, 4, 5, 6, 7, 8, 7, 6, 7, 8, 9, 10, and 11. In this case, the control circuit 23 utilizes a random number RN to insert a set of reverse operation and normal operation respectively having one step and two steps after rounds 3 and 8. That is, the control circuit 23 determines one or more positions and number of steps for inserting reverse operation and normal operation that turns back the result data of the reverse operation to the original value of the reverse operation during a processing step of encryption operation or decryption operation to be executed multiple times in cryptographic processor, and thereby controls the round, that is, the processing step, of the cryptographic processor. The number of steps is one or more number of times of reverse operation, and normal operation corresponding to the reverse operation to be inserted, respectively.

### [Operation]

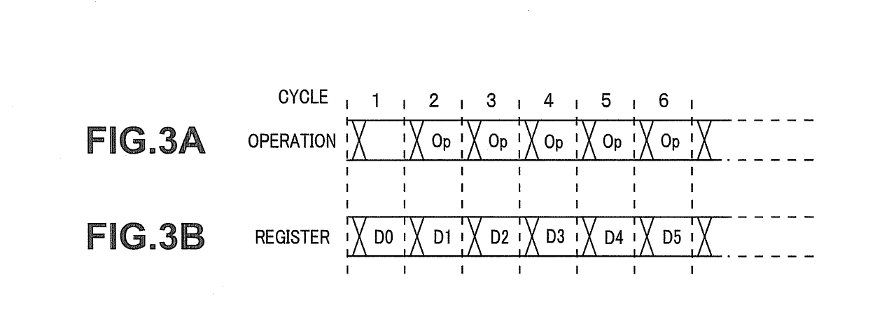

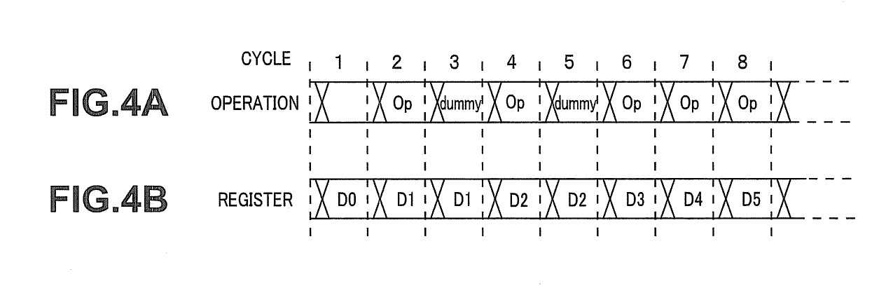

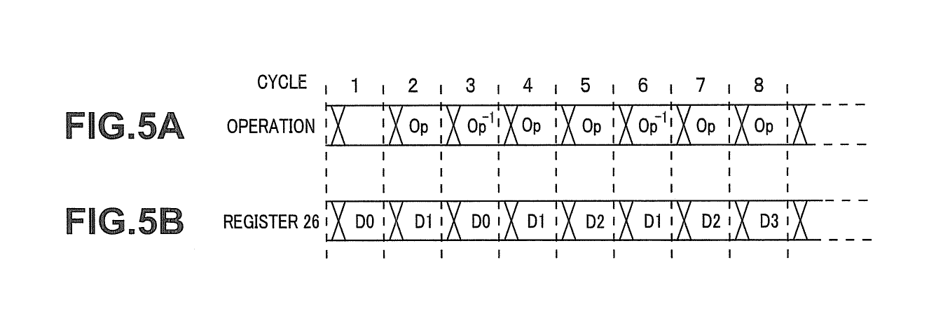

FIGS. 3A to 5B are diagrams to illustrate the operation of the cryptographic processing circuit of the present embodiment. FIGS. 3A and 3B are timing charts to show the processing status in a case in which conventional dummy processing is not included. FIGS. 4A and 4B are timing charts to show the processing status in a case in which conventional dummy processing is included. FIGS. 5A and 5B are timing charts to show the processing status in a case in which reverse operation processing of the present embodiment is used. FIGS. 3A to 5B show the kind of operation for each operation cycle, and the data to be saved in the register. Note that operation of one round is executed in one cycle. FIGS. 3A, 4A, and 5A show the timing of operation processing in each cycle, and FIGS. 3B, 4B, and 5B show the content of the register in each cycle.

In a conventional normal cryptographic processor shown in FIGS. 3A and 3B, result data D0 of cryptographic processor of a first operation cycle 1 becomes input data of a next cycle 2; a predetermined cryptographic processor (encryption operation or decryption operation) Op is executed on the input data; and output data D1 thereof is held in a predetermined register to become input data of a next cycle 3. Thereafter, similar cryptographic processor is repeated.

A predetermined number of cryptographic processor is executed so that finally encrypted data or decrypted data is held in a predetermined register.

In the cryptographic processor of the case of FIG. 4A in which conventional dummy processing is included, dummy operation is inserted at some point during the normal cryptographic processor of FIG. 3A. The data before the execution of dummy operation is retained as it is in the predetermined register. Therefore, in a cryptographic processor where dummy processing is included, the overall processing time is extended by the time for the execution cycle of the dummy operation as shown in FIG. 4A.

The data retained in the register will be data D1, D2, D3, D4, . . . corresponding to the cryptographic processor to be executed at each operation cycle in the case of FIG. 3B, but will be data D0, D1, D1, D2, D2, D3, D4, D5, . . . in the case of FIG. 4B.

In the cases of FIGS. 5A and 5B, for example, encryption operation is executed at the encryption circuit 21 and decryption operation is executed at the decryption circuit 22 for an initial value INd. In the case of encryption operation, at the selector 24, the output data generated in the encryption circuit 21 is selected and outputted based on the selection signal SL1 from the control circuit 23. That is, the output of the encryption circuit 21 is selected at the timing of cycle 1. The first output data D0 of cycle 1 is retained in the register 26 and becomes input data of next cycle 2.

At cycle 2 as well, encryption operation is executed at the encryption circuit 21, and decryption operation is executed at the decryption circuit 22 for the output data D0 of the register 26. At the selector 24, the output data D1 generated in the encryption circuit 21 is selected and outputted based on the selection signal SL1 from the control circuit 23. That is, at the timing of cycle 2 as well, the output of the encryption circuit 21 is selected. The output data D1 is retained in the register 26 and becomes input data of next cycle 3.

At cycle 3 as well, encryption operation is executed at the encryption circuit 21, and decryption operation is executed at the decryption circuit 22 for the output data D1 of the register 26. Cycle 3 is a cycle of reverse operation. Therefore, at the selector 24, the output data of the decryption circuit 22 that executes reverse operation of encryption operation for the data D1 of the register 26 is selected and outputted based on the selection signal SL1 from the control circuit 23. That is, at the timing of cycle 3, the output of the decryption circuit 22 is selected. Since the output data is the result data of reverse operation on the data D1, the output data is the data D0. The data D0 is retained in the register 26 and becomes input data of next cycle 4. That is, since cycle 3 is a cycle of reverse operation, data to be outputted to the register 26 will become the result data DO of cycle 1 that is the preceding cycle of cycle 2.

At cycle 4 as well, encryption operation is executed at the encryption circuit 21 and decryption operation is executed at the decryption circuit 22 for the output data D0 of the register 26. At the selector 24, the output data D1 generated in the encryption circuit 21 is selected and outputted based on the selection signal SL1 from the control circuit 23. That is, at the timing of cycle 4, the output of the encryption circuit 21 is selected. The output data D1 is retained in the register 26 and becomes input data of next cycle 5.

At cycle 5 as well, encryption operation is executed at the encryption circuit 21 and decryption operation is executed at the decryption circuit 22 for the output data D1 of the register 26. At the selector 24, the output data D2 generated in the encryption circuit 21 is selected and outputted based on the selection signal SL1 from the control circuit 23. The output data D2 is retained in the register 26 and becomes input data of next cycle 6.

Similarly, at cycle 6, the data D1 of the decryption operation that executes reverse operation Op⁻¹ for the data D2 is held in the register 26. At cycle 7, encryption operation Op is executed for the data D1 and data D2 is outputted as result data to the register 26. Similarly, at cycle 8, encryption operation Op is executed for the data D2, the data D3 is outputted as the result data to the register 26.

As a result, the data to be held in the register 26 varies as shown in FIG. 5B. That is, the data to be held in the register 26 is in such a way as D0, D1, D0, D1, D2, D1, D2, D3, . . . , where one step of reverse operation Op⁻¹ and normal operation Op are inserted after cycle 2, and also one step of reverse operation Op⁻¹ and normal operation Op are inserted after cycle 5.

As described so far, in the case of encryption processing, when encryption operation as cryptographic processor is executed for certain data DA, data DB is outputted as result data thereof. However, when decryption operation, which is reverse operation of encryption operation, is executed for the data DB, the result data returns to the data DA before encryption. Then, the processing as shown in FIGS. 5A and 5B is realized by the control circuit 23 outputting a selection signal SL1 corresponding to one or more positions and number of steps where reverse operation is inserted and which are determined randomly based on a random number RN.

Although description has been made on the case of encryption operation so far, the same goes for the case of decryption operation. Note that reverse operation in the case of decryption operation is encryption operation.

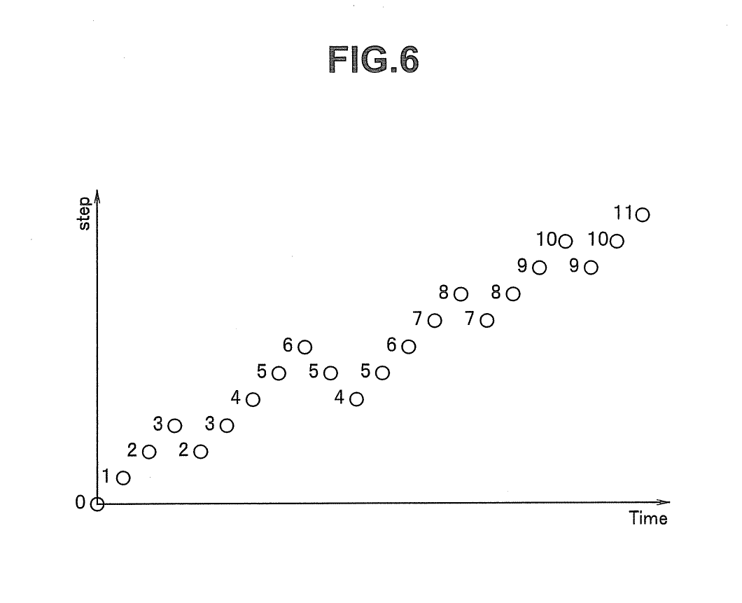

FIG. 6 is a graph to show an example of the temporal change of the step of cryptographic processor of the present embodiment. In FIG. 6, the horizontal axis indicates time and the vertical axis indicates the step, wherein a rightward ascent indicates the execution of normal operation, and a rightward descent indicates the execution of reverse operation. When the cryptographic processor is encryption operation, the normal operation is encryption operation, and the reverse operation is decryption operation. When the cryptographic processor is decryption operation, the normal operation is decryption operation, and the reverse operation is encryption operation. As shown in FIG. 6, while an 11 number of processing steps are executed in the case of AES, reverse operations, and normal operations corresponding to the reverse operations are inserted in the middle. Therefore, the 11 number of processing steps proceed while moving backward in the middle. As a result of that, result data varies in a different fashion from the result data of normal operation.

In FIG. 6, after step 3, the processing temporarily returns to step 2 thereafter returning to step 3 again. Further, after step 6, the processing returns by two steps in such a way that the processing returns to step 5 and further returns to step 4 thereafter returning to step 5 again and further returning to step 6. After steps 8 and 10 as well, the processing returns by one step as in the case of step 3. That is, in the cryptographic processing apparatus of the present embodiment, reverse operation is randomly inserted at some point during normal operation so that the timing of normal operation changes as well as the value of data changes. That is, the change of the value of data is a change due to the processing in which a first operation for converting a first value, which is input data to be subjected to cryptographic processor, or intermediate data during cryptographic processor, into a second value and a second operation for converting the second value into the first value are successively performed at least one time.

In FIG. 6, the reverse operation to return to step 2 following step 3 is the first operation for converting a first value, which is the intermediate data during cryptographic processor, into a second value; and the normal operation to return to step 3 following the reverse operation is the second operation for converting the second value into the first value.

Similarly, the reverse operation of two steps to return to step 4 from step 6 is the first operation for converting a first value, which is intermediate data during cryptographic processor, into a second value; and the normal operation of two steps to return to step 6 from step 4 following the reverse operation is the second operation for converting the second value into the first value. That is, the control circuit 23 controls the cryptographic operation processing section such that when the cryptographic processor executed in the cryptographic operation processing section is encryption operation, decryption operation which is reverse operation is executed a multiple number of times successively, and thereafter encryption operation is executed the same multiple number of times.

Although the above described description refers to the case in which the cryptographic processor is encryption operation, the same goes for the case in which the cryptographic processor is decryption operation. The first operation is decryption operation, which is reverse operation of encryption operation, when the cryptographic processor is encryption operation, and is encryption operation, which is reverse operation of decryption operation, when the cryptographic processor is decryption operation. Further, the second operation is encryption operation when the cryptographic processor is encryption operation, and is decryption operation when the cryptographic processor is decryption operation.

As so far described, according to the present embodiment, since reverse operation processing is randomly inserted during cryptographic processor without using a register circuit that retains data and a dummy key for dummy operation, and the processing time is varied only by actual cryptographic processor, it is possible to realize a cryptographic processing circuit which has resistance against power analysis attack.

### Second Embodiment

Next, a second embodiment will be described. Although cryptographic processor is executed by a circuit which is hardware in the first embodiment, the second embodiment differs from the first embodiment in that cryptographic processor is executed by a software program (hereafter, simply referred to as software).

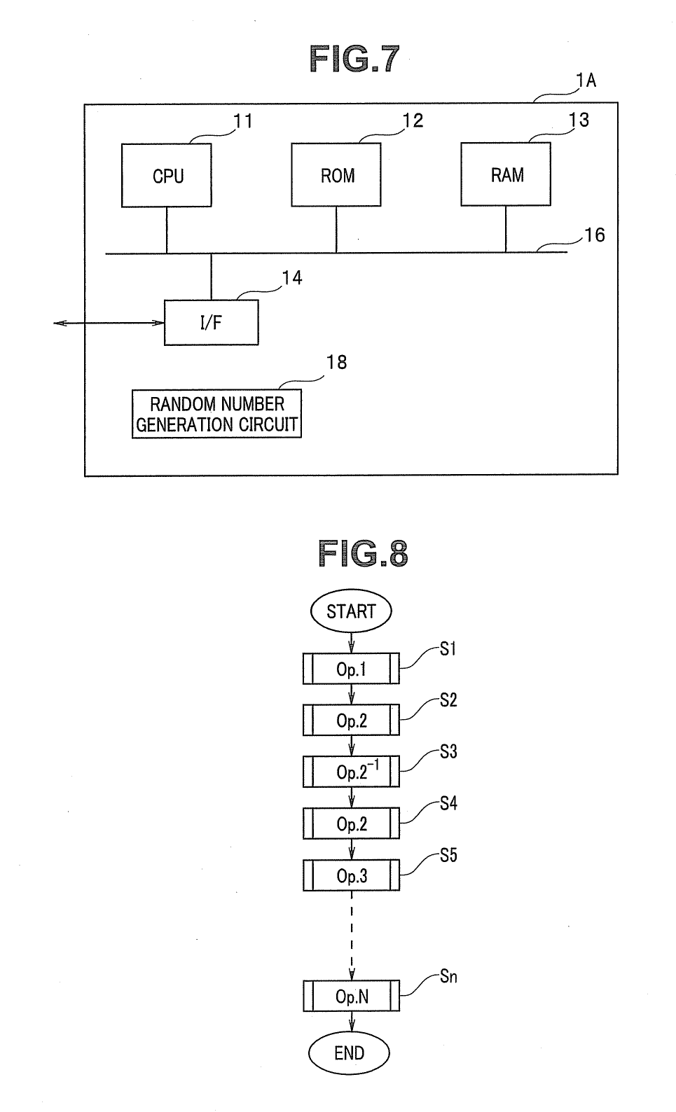

FIG. 7 is a configuration diagram to show the configuration of a cryptographic processing apparatus 1A relating to the present embodiment. In FIG. 7, the same components as those of FIG. 1 will be given the same reference characters, thereby omitting the description thereof. As shown in FIG. 7, the cryptographic processing apparatus 1A does not include the I/F 17 and the cryptographic circuit module 15 in the cryptographic processing apparatus 1 of FIG. 1.

Although the cryptographic processing apparatus 1A performs cryptographic processor by software, the execution of the software is performed by a CPU 11 as a control section. In place of a register 26 that retains cryptographic processing results, a storage area of a RAM 13 is utilized. Further, in place of the round control counter 31, the storage area of the RAM 13 is utilized. The CPU 11 executes cryptographic processor while controlling the increase and decrease of a counter value of a round control counter based on a random number RN from a random number generation circuit 18 which is a random number generation section. The result data of cryptographic processor will be written into the storage area of the RAM 13.

FIG. 8 is a flowchart to show an example of processing flow when the CPU 11 determines and executes execution steps of cryptographic processor based on a random number RN. The CPU 11 inserts reverse operation processing, and normal operation processing corresponding to the reverse operation thereof at one or more positions of the step determined based on random number RN by a number of steps determined by the random number RN during 11 processing steps corresponding to an 11 number of rounds of AES, based on the random number RN.

In FIG. 8, “n” (n is an integer) times of cryptographic processing steps: steps S1, S2, S3, S4, S5, . . . , and Sn, are executed successively. That is, while N times (N is 11 in the case of AES) of cryptographic processor are executed, (n-N) times of reverse operation processing (including normal operation processing corresponding to the reverse operation processing) are inserted in one or more locations. In FIG. 8, one time of reverse operation processing Op2⁻¹ is inserted at a position after step S2 and, after the reverse operation processing, the same cryptographic operation processing (normal operation processing) Op2 as in step S2 is inserted again. The result data when the processing of step S3 has ended is the same as the result data when the processing of step S1 has ended. The result data when the processing of step S4 has ended is the same as the result data when the processing of step S2 has ended.

In FIG. 8, for example, the reverse operation processing in step S3 following step S2 is a first operation for converting a first value, which is intermediate data during cryptographic processor, into a second value, and the operation processing in step S4 following the reverse operation is a second operation for converting the second value into the first value.

In this way, in the present embodiment, as in the first embodiment, the CPU 11 determines one or more positions and number of steps for inserting reverse operation processing and normal operation corresponding to the reverse operation processing during N times of processing steps, based on random number RN thereby controlling the processing steps of cryptographic processor.

Therefore, according to the cryptographic processing apparatus of the present embodiment, since reverse operation processing is randomly inserted during cryptographic processor without using a register circuit that retains data and a dummy key for dummy operation, and the processing time is varied only by actual cryptographic processor, it is possible to realize a cryptographic processing circuit which has resistance against power analysis attack.

Note that although the above described example has been described by way of cryptographic processor of AES, the cryptographic processor may be of other than AES. Further, although processing content is the same in each step in the above described example, the processing content of each step may be different from each other.

### Third Embodiment

Next, a third embodiment will be described. While a cryptographic processing apparatus which has resistance against power analysis attack is disclosed in the first and second embodiments, the cryptographic processing apparatus of the present embodiment not only has resistance against power analysis attack, but also has resistance against fault attack. That is, according to the present embodiment, a cryptographic processing apparatus is provided that has resistance against power analysis attack by randomly inserting reverse operation processing in a step, that is, a round of cryptographic processor, and that has resistance against fault attack which performs laser irradiation, noise provision, and so on to an IC chip.

The fault attack causes some failure during cryptographic processor thereby causing an error in the result in the middle of the processing. The analysis method thereof is a method of extracting the result data of cryptographic processor performed on erroneous data to collect much of such data, and analyzing the large amount of data to extract a cryptographic key.

In a conventional cryptographic processing apparatus that performs dummy operation, when a failure is caused during dummy processing, the operation result will not be affected, but if a failure is caused during normal cryptographic processor other than during dummy operation, cryptographic processor is performed using erroneous data. Therefore, since failure may be caused during processing of dummy data and so on, insertion of dummy operation has an effect that the probability of occurrence of failure can be reduced against fault attack. However, a problem exists in that obtaining a large number of operation results by increasing the number of times of failure imposition allows the analysis of confidential information.

In the case of fault attack, result data that is finally outputted by a cryptographic processing apparatus is utilized. Accordingly, the cryptographic processing apparatus of the present embodiment is configured to for example, halt cryptographic processor upon detecting that fault attack has been made. As a result, the analyst cannot extract a cryptographic key and the like to analyze, because result data of cryptographic processor is not outputted.

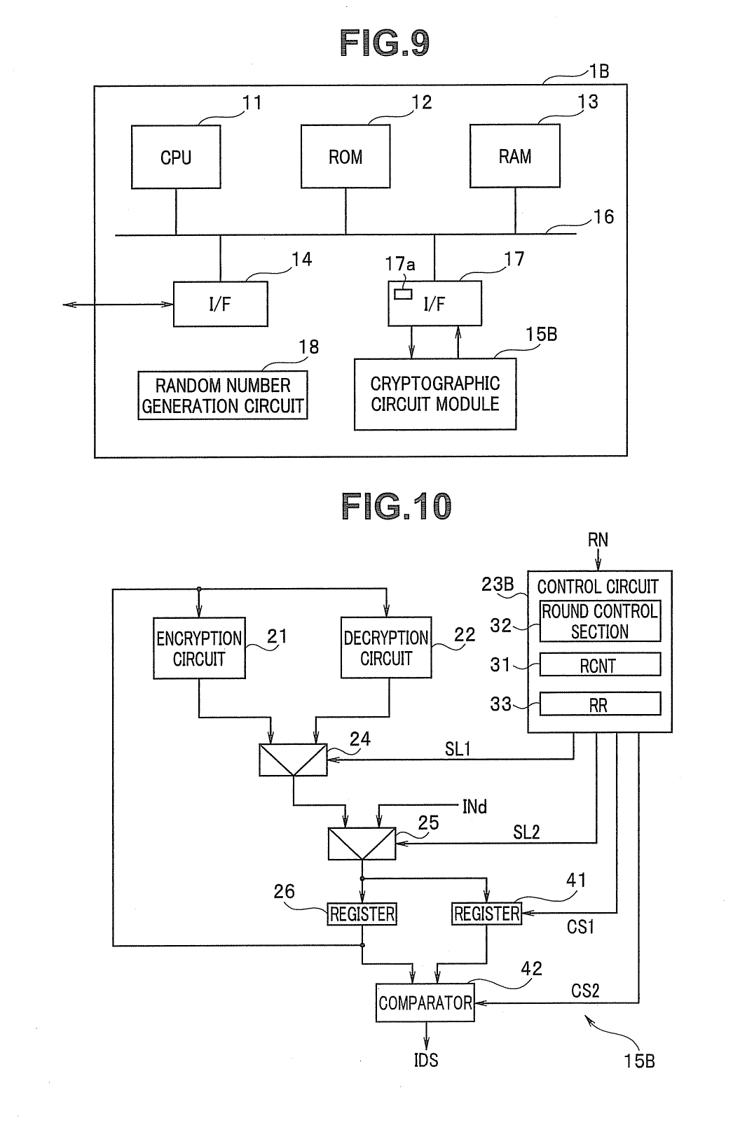

FIG. 9 is a configuration diagram to show the configuration of a cryptographic processing apparatus 1B relating to the present embodiment. In FIG. 9, the same components as those of FIG. 1 are given the same reference characters thereby omitting the description thereof. As shown in FIG. 9, a flag register 17a for retaining flag data as alarm data is provided in an I/F 17.

Note that in the present embodiment, although the register 17a is provided in the I/F 17, it may be provided in a location other than the I/F 17 or a predetermined region within a RAM 13 may be used in place of a register.

FIG. 10 is a block diagram to show the configuration of a cryptographic circuit module 15B relating to the present embodiment. In FIG. 10, the same components as those of the cryptographic circuit module 15 of FIG. 2 are given the same reference characters, thereby omitting the description thereof.

A control circuit 23B of the cryptographic circuit module 15B includes a round register 33. The round register 33 is a register that stores the round, that is, the step, immediately before reverse operation is inserted. Upon insertion of reverse operation, the control circuit 23B as a control section stores the value of the immediate preceding round in the round register 33. For example, when reverse operation processing is inserted after round 3, the control circuit 23B causes the value “3” of round 3 to be held in the round register 33.

Further, the cryptographic circuit module 15B includes a register 41 and a comparator 42. The register 41 receives input of the output of a selector 25, and holds the output data of the selector 25 according to a control signal CS1 from the control circuit 23B.

The control circuit 23B as a control section determines one or more positions and number of steps of reverse operation and normal operation corresponding thereto to be inserted into encryption operation or decryption operation which is executed multiple times in cryptographic processor, based on a random number RN generated in the random number generation circuit 18, and controls the execution of the encryption circuit 21 and the decryption circuit 22.

The control signal CS1 is generated based on the timing of insertion of reverse operation processing, and the data of the selector 25 is held in the register 41 according to the timing of the control signal CS1. For example, when reverse operation processing is inserted after round 3, the control signal CS1 is outputted such that the result data of round 3 before the reverse operation processing is executed is stored.

The control circuit 23B as a control section includes a circuit for comparing the value of a round control counter (RCNT) 31 and the value of the round counter 33. In the control circuit 23B, after a round value is retained in the round counter (RR) 33, the value of the round control counter (RNCT) 31 and the value of the round counter 33 are compared to determine whether or not they are consistent with each other.

Moreover, the comparator 42 compares two data held in the two registers 26 and 41 based on the control signal CS2 from the control circuit 23B. When the two data are inconsistent with each other, the comparator 42 outputs an inconsistency detection signal IDS as an alarm signal.

The timing at which the comparator 42 compares the two data, that is, the timing at which the control signal CS2 is outputted is when the values of the round register 33 and the round control register 31 become consistent with each other. That is, the control circuit 23B outputs the control signal CS2 such that the result data of the previous round of the reverse operation, which has been saved in the register 41 when the reverse operation has started, is compared with the result data when the same round with that of the saved result data is executed.

The detection signal IDS of the comparator 42 is outputted as a signal for writing, for example, “1” as flag data into a flag register 17a of the I/F 17. The data of the flag register 17a is monitored by the CPU 11. The CPU 11 controls the cryptographic circuit module 15B so that its operation is stopped when the flag data becomes “1”. Alternatively, the CPU 11 can determine whether or not fault attack has been made by confirming the value of flag data in the flag register 17a or the RAM 13 after the execution of the cryptographic circuit module 15B.

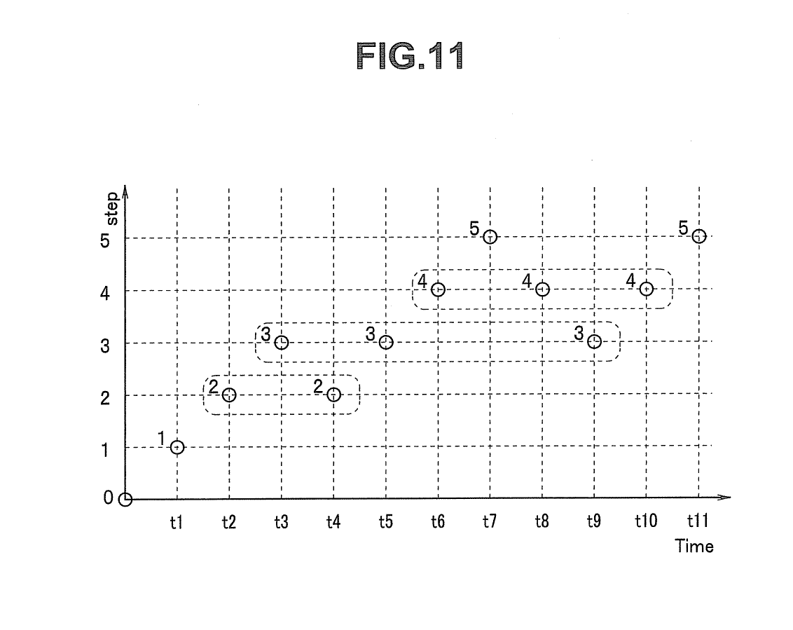

FIG. 11 is a diagram to illustrate the timing at which the comparator 42 of the present embodiment makes comparison. In FIG. 11, normal operation is executed at times t1, t2, t3, t5, t6, t7, and t10 and reverse operation is executed at times t4, t8, and t9. For example, after step 3, which corresponds to round 3, one reverse operation processing is inserted at the timing of time t4, and after the reverse operation processing, the step returns to step 3 at the timing of time t5. The result data of step 3 appears in the execution results of times t3, t5, and t9 and the result of step 4 appears in the execution results of times t6, t8, and t10.

Therefore, as described later, when, for example, the result data of step 3 at time t3 is held in the register 41 and is compared with the result data when the result of same step 3 appears, the two data will be consistent with each other if failure has not occurred during that period, and the two data will be inconsistent with each other if failure has occurred. That is, failure can be detected by comparing the two data.

The value of the round control counter (RCNT) 31 has varied in such a way as 1, 2, 3, 2, 3, . . . . The round counter (RR) 33 retains the value of the step immediately before the first reverse operation processing is inserted (here, the first step 3).

The control circuit 23B detects that the value of the round control counter (RCNT) 31 and the value of the round counter 33 become consistent with each other at the timing of time t5, and generates the control signal CS2 and outputs the signal to the comparator 42 at that timing.

For example, when the cryptographic processing apparatus 1B has been subjected to fault attack between time t3 and time t5, the result data of cryptographic processor may be different between the first step 3 and the second step 3. Therefore, the comparator 42 detects such inconsistency and outputs a detection signal IDS.

In the case of FIG. 11, after the first step 5, two steps of reverse operation processing are inserted. In this case, the round counter (RR) 33 retains a round value “5” at the timing of time t7, and when thereafter the round control counter (RCNT) 31 becomes “5”, the values of the register 26 and the register 41 are compared in a similar manner. Thus, in this case as well, if the cryptographic processing apparatus 1B has been subjected to fault attack between time t7 and time t11, and the operation result data of cryptographic processor is different between the first step 5 and the second step 5, the comparator 42 will detect that inconsistency and output the detection signal IDS.

The detection signal IDS of the comparator 42 is provided to, for example, the control circuit 23B, or to the CPU 11 via the I/F 17. The control circuit 23B or the CPU 11 can halt the cryptographic processor in the cryptographic circuit module 15B upon receiving the detection signal IDS. By doing so, the final result of cryptographic processor will not be outputted. Thus, if the final result is not outputted in a cryptographic processing apparatus, it will be effective in protecting against failure imposition attacks.

Note that the detection signal IDS may be provided as an interrupt signal to the CPU 11.

Further, although in the above described example, a round value is retained according to the timing of inserting reverse operation, and also the result data is stored, configuration may be such that result data for each round is retained entirely or randomly so as to detect whether or not there is inconsistency between the result data in the same rounds within the retained result data.

For example, round 2 has occurred two times in FIG. 11. Moreover, rounds 3 and 4 have occurred three times. Therefore, if there are two or more result data of the same round within the randomly retained result data, those result data may be compared to detect whether or not there is inconsistency between them. For example, in FIG. 11, if there are result data at time t3 and time t9 as the result data of round 3 within the randomly retained result data, those data are compared.

Alternatively, configuration may be such that the result data of a round, which is determined by a random number, is retained, and thereafter when the same round as the determined round appears, the data of that round is compared with the retained result data.

As described so far, the cryptographic processing apparatus of the present embodiment is configured such that intermediate data of cryptographic processor are retained in the register 41, and when a certain step is repeatedly executed, the result data of the step is compared with the intermediate data to detect that failure has occurred during the cryptographic processor. That is, the control circuit 23B compares a value immediately before reverse operation with a value of the operation result of reverse operation (and normal operation corresponding to the reverse operation), and halts the execution of cryptographic processor in the cryptographic operation processing section when both values are inconsistent with each other.

Therefore, the cryptographic processing apparatus of the present embodiment can have resistance against power analysis attack, because it is configured such that reverse operation processing is randomly inserted during cryptographic processor without using a register circuit for retaining data and a dummy key for dummy operation, and the processing time is varied only by actual cryptographic processor.

Further, the cryptographic processing apparatus of the present embodiment detects whether or not there is difference between two result data of the same round of cryptographic processor. Since configuring that the cryptographic processor is halted when there is difference between the two result data will inhibit the final result of the cryptographic processor, that is, for example, a cryptogram for a plain text from being outputted, the cryptographic processing apparatus of the present embodiment can have resistance against fault attack.

Note that although the present embodiment has been described by way of an example which is implemented by hardware circuit, as with the second embodiment, when cryptographic operation is implemented by software, functions such as the above described comparator and so on can be implemented by software. Therefore, the cryptographic processing apparatus of the present embodiment can be implemented by software as well.

### Fourth Embodiment

The present embodiment is an example of cryptographic processing apparatus which includes a cryptographic processing section. Here, description will be made by way of an example of a cryptographic processing section utilizing DES.

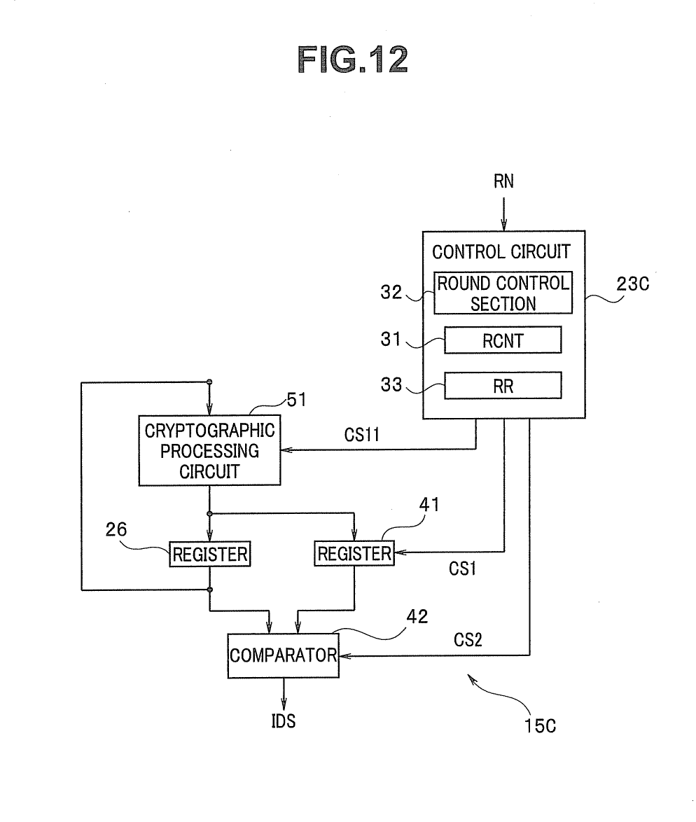

FIG. 12 is a block diagram to show the configuration of a cryptographic circuit module 15C of the cryptographic processing apparatus of the present embodiment. In FIG. 12, the same components as those of the cryptographic processing apparatus of FIG. 10 will be given the same reference characters, thereby omitting the description thereof.

The cryptographic circuit module 15C includes a control circuit 23C, a cryptographic processing circuit 51, two registers 26 and 41, and a comparator 42.

The cryptographic processing circuit 51 executes cryptographic processor of either encryption operation or decryption operation based on a control signal CS11 from the control circuit 23C. The cryptographic processing circuit 51 makes up a cryptographic operation processing section which can execute cryptographic processor of encryption operation and decryption operation. The cryptographic processing circuit 51 includes a round function section of DES, and the round function section includes a scramble section and a key schedule section. The scramble section includes an f-function section and an exclusive logical OR section. The output of the cryptographic processing circuit 51 is provided to the register 26, and result data retained in the register 26 becomes input data of the cryptographic processing circuit 51 again so that round processing is repeated 16 times.

The control circuit 23C as a control section includes a round control counter 31, a round control section 32, and a round counter 33. The control circuit 23C causes the cryptographic processing circuit 51 to execute cryptographic processor of encryption operation or decryption operation while making the round control section 32 increase or decrease the round control counter 31. The control circuit 23C outputs a key insertion instruction signal for inserting decryption operation, which is reverse operation, or encryption operation in the middle, based on a random number RN that has been inputted and a switching control signal for performing switching so as not to exchange two input data to the f-function section and the exclusive logical OR section.

That is, the control circuit 23C causes the cryptographic processing circuit 51 to execute cryptographic processor of either encryption operation or decryption operation while inserting reverse operation in the middle by providing the control signal CS11 that includes a key insertion instruction signal for reverse operation processing and a switching control signal.

The register 41 retains result data of the round immediately before reverse operation. The control circuit 23C outputs a control signal CS2 to the comparator 42 when the value of the round control counter 31 becomes consistent with the value of the round register 33. The comparator 42 compares the result data immediately before reverse operation with the result data (data of the register 26) when the round returns to a same round as that immediately before reverse operation, and if there is inconsistency, outputs an inconsistency signal IDS.

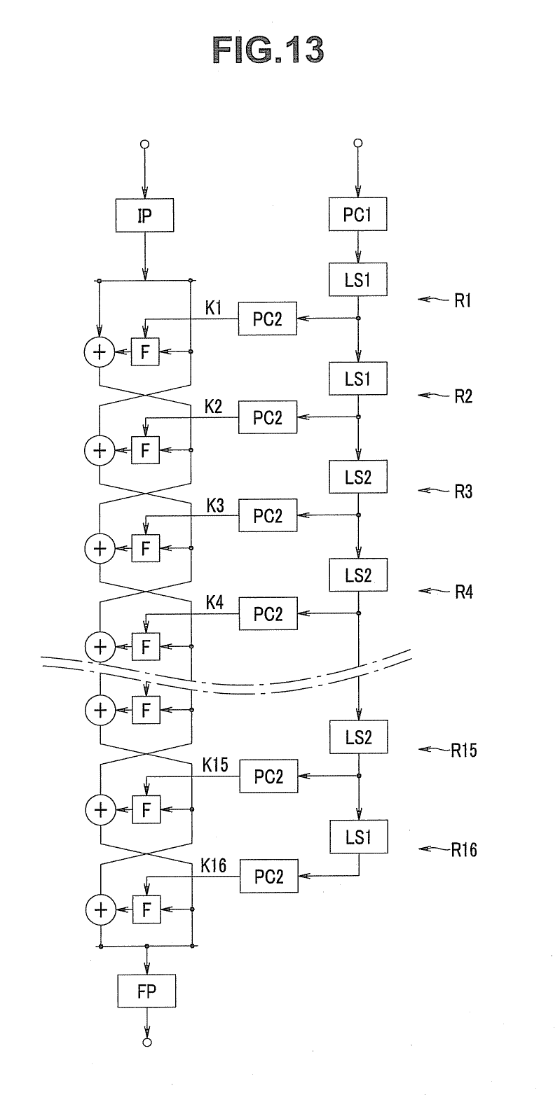

FIG. 13 is a diagram to show the algorithm of DES. The DES algorithm is made up of initial transposition (IP), final transposition (FP), key operation (righthand side), and data operation (lefthand side). The initial transposition and the final transposition are in a relationship of reverse operation with each other. In data operation, a same operation is executed repeatedly. In FIG. 13, round 1 (R1) to round 16 (R16) are shown. In the decryption operation of DES, although data operation is the same operation, key operation is executed in a reverse procedure with respect to the procedure of encryption operation. That is, although key data K is generated in the order of K1, K2, K3, . . . , K16 from round 1 to round 16 and is provided to the f-function section in the case of encryption operation, the key data K is generated in the order of K16, K15, K14, . . . , K1 from round 1 to round 16 and is provided to the f-function section in the case of decryption operation.

While in normal operation, operation to exchange two data of the left and right of the f-function section is performed as shown in FIG. 13, processing without exchanging the left and right input data at the time of change from encryption operation to decryption operation makes it possible to implement reverse operation.

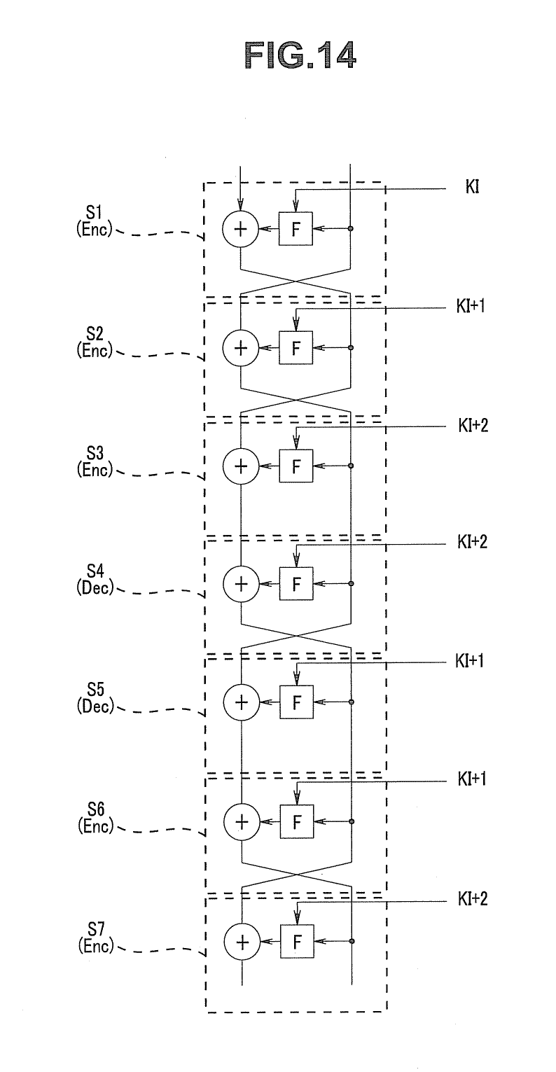

FIG. 14 is diagram to show an example in which reverse operation is inserted into encryption operation, showing a part of the algorithm of DES. In FIG. 14, step 1 (S1) corresponding to a certain round, step 2 following step 1 (S2), step 3 (S3), . . . step 7 (S7) are shown. Here, two steps of reverse operation are inserted after S3.

Encryption processing (Enc) is being performed in S1, S2, S3, S6, and S7 and decryption processing (Dec) is being performed in S4 and S5. As a result of the same key data KI+2 as that of S3 being used in S4, the result data of S4 has become the same as the result data of S2.

Further, as a result of the same key data KI+1 as that of S2 being used in S5 following S4, the result data of S5 has become the same as the result data of S1. As a result of the same key data K1+1 as that of S2 being used in S6 following S5, the result data of S6 has become the same as the result data of S4 and S2.

Further, since the same key data KI+2 as that of S3 is used in S7, the result data of S7 has become the same as the result data of S3.

Here, in S4 and S6, switching is performed by a switching control signal so that input data to the f-function section and the exclusive logical OR section are not exchanged with each other.

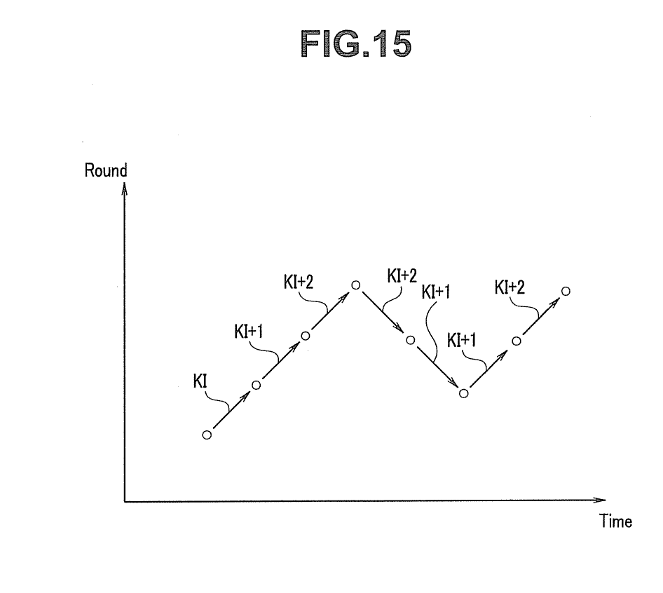

FIG. 15 is a diagram to show the processing flow from S1 to S7 of FIG. 14. Here, two steps of reverse operation are inserted and the key data has changed in such a way as KI, KI+1, KI+2, KI+2, KI+1, KI+1, and KI+2.

As described so far, the cryptographic processing apparatus of the present invention is configured such that reverse operation (decryption operation) can be inserted during encryption operation, or reverse operation (encryption operation) can be inserted during decryption operation in DES operation, and as a result of which the processing time changes, thereby making it possible to provide resistance against power analysis attack.

Further, as with the third embodiment, since the round and the data immediately before inserting reverse operation are retained, and are compared with later data of the same round to output an inconsistency detection signal IDS, it is possible to realize a cryptographic processing apparatus that has resistance against fault attack.

Note that since it is adequate if processing to return to the result data immediately before reverse operation is performed after reverse operation, the key data to be used for reverse operation may not be the same as the key data used for the step immediately before reverse operation.

In the example of FIG. 14, the method of providing key data to the f-function section of the cryptographic processing circuit 51 is configured such that two steps of reverse operation are inserted one time. Moreover, the key data for reverse operation is configured to be the key data used in the step immediately before reverse operation so as to return to the result data of the step immediately before the reverse operation. In the case of FIG. 14, the key data of S4 is the same as the key data used in S3. Further, since the result data of S4 will become the same as the result data of S2, the key data of S5 will be the same as the key data used in S2. Moreover, the key data of S6 and S7 are the same as the key data of S5 and S4, respectively such that the result data of S6 becomes the same as the result data of S4, and the result data of S7 becomes the same as the result data of S3.

Further, when one step of reverse operation processing is inserted one time, in order to make the processing return to the result data before the operation processing of the step immediately before reverse operation processing as described above, the key data for reverse operation processing and the key data for the operation processing following that will be both the key data used for the step immediately before reverse operation. For example, when reverse operation processing is inserted after S2, the key data will be K1, K2, K2, K2, K3, K4, . . . .

However, if the key data for reverse operation processing and the key data for the operation processing following that are the same, the key data may be different from the key data used for the step immediately before reverse operation processing.

For example, when reverse operation processing is inserted after S2, the key data may be K1, K2, K5, K5, K3, K4, . . . . Even if the key data is inserted as described above, there will be no problem since it returns to the result data of the step immediately before reverse operation processing.

### [Variations]

Next, variations of the above described three embodiments will be described.

In each embodiment described above, when cryptographic processor for an inputted initial value INd is executed, one or more reverse operation having one or more steps are inserted in the cryptographic processor. However, in the present first variation, preprocessing in which normal operation and reverse operation thereof are combined is inserted for the inputted initial value INd before the cryptographic processor for the inputted initial value INd.

In the preprocessing of the present variation, processing which combines key data that is determined based on a random number RN, and normal operation and reverse operation that are determined based on a random number RN is executed. Then, when the execution result thereof becomes equal to the inputted initial value INd, the cryptographic processing apparatus ends the preprocessing and executes the cryptographic processor of the above described each embodiment.

Further, in addition to that, when the cryptographic processor of the above described each embodiment ends, postprocessing which is processing combining normal operation and reverse operation thereof, is inserted for the result data at that moment (final result data). In the postprocessing, processing which combines key data that is determined based on a random number RN, and normal operation and reverse operation that are determined based on a random number RN is executed. Then, when the execution result thereof becomes equal to the final result data, the cryptographic processing apparatus ends the postprocessing.

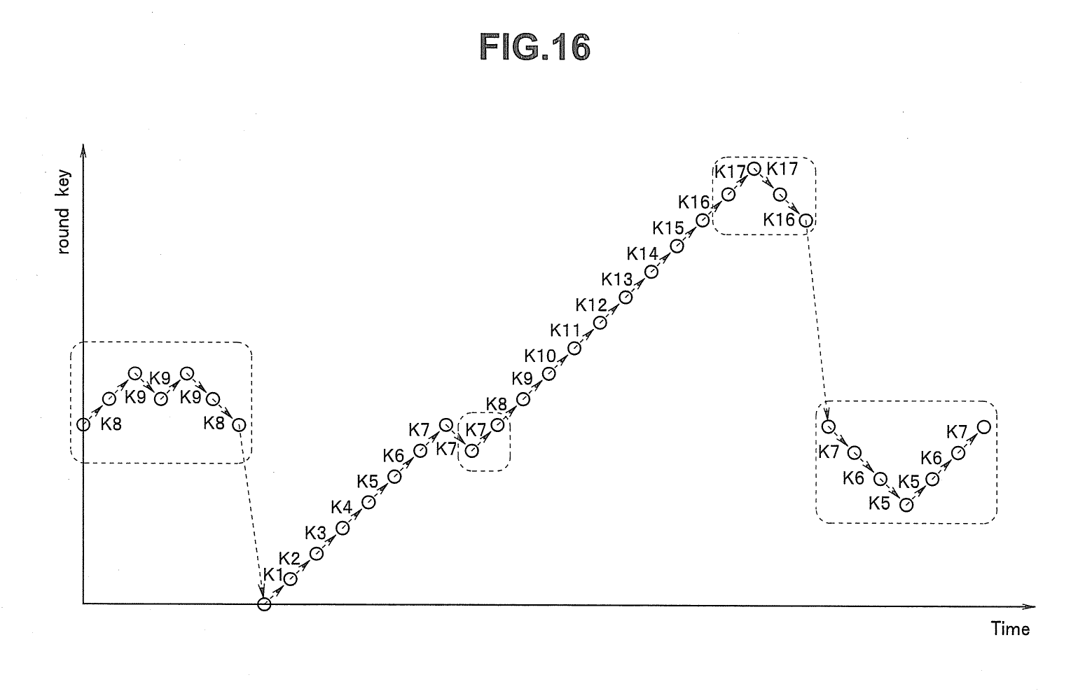

FIG. 16 is a diagram to illustrate the operation of the first variation. In FIG. 16, in the preprocessing of the cryptographic processor of DES, processing which combines key data K8 and K9 that are determined based on a random number RN for the inputted initial value INd, and normal operation and reverse operation that are determined based on a random number RN is being executed. Then, after 6 times of steps, since the data becomes equal to the initial value INd, the preprocessing is ended and cryptographic processor is being executed.

To be specific, in FIG. 16, the key data K8 is a round key to be used in the eighth round. Moreover, a rightwardly ascending arrow indicates that encryption operation which is normal operation is being executed, and a rightwardly descending arrow indicates that decryption operation which is reverse operation is being executed. A portion encircled by a dotted line represents a portion in which operation other than cryptographic processor is being executed. The left-hand side portion encircled by a dotted line is a preprocessing portion to be performed before the start of cryptographic processor. The lower middle portion encircled by a dotted line is an inserted portion of reverse operation and normal operation to be performed during cryptographic processor. The upper right-hand side portion encircled by a dotted line is a postprocessing portion to be performed at the end of cryptographic processor. Further, the lower right-hand side portion encircled by a dotted line is a postprocessing portion to be performed after the end of cryptographic processor.

In power analysis, generally the first round and the last round will be the targets of analysis. Therefore, in the present variation, the start or end status will change regarding the first and last rounds. Normally, cryptographic processor is implemented by repeating the same operation (round), and in such configuration, a separate key (round key) is used in each round.

In FIG. 16, in cryptographic processor, operation is performed using a different key as the key to be used in the first round. In an operation example shown in FIG. 16, first, normal operation (encryption operation) is performed using the key for round 8, and then normal operation using the key for round 9, reverse operation (decryption operation) using the key for round 9, normal operation using the key for round 9, reverse operation using the key for round 9, and reverse operation using the key for round 8 are performed. As a result of such processing, the result data will return to the original data. In the next operation, cryptographic processor is started by starting normal operation (encryption operation) using the key for round 1. That is, since before the key for round 1 is used, operation in which only the key is different and other processing excepting the key is the same is performed, it is possible to vary the result data at the start of the cryptographic processor using the key for round 1.

After the cryptographic processor ends, in the postprocessing, processing which combines key data K17, K16, K7, K6, and K5 that are determined based on a random number RN, and normal operation processing and reverse operation processing that are determined based on a random number RN is performed for the final result data. Then, after 10 steps, the data becomes equal to the final result data, and thereby the postprocessing is ended.

To be specific, by repeating normal operation and reverse operation a same number of times by using keys different from original ones at the end of cryptographic processor as well, it becomes possible to vary the result data at the end of the last round. Further, by performing normal operation and thereafter reverse operation using a round key that is not defined in the cryptography algorithm following the processing at the last round, it further becomes possible to vary the processing time.

As so far described, in the first variation, the control section inserts successive reverse operation (and normal operation corresponding to the reverse operation) of at least one time at least one of before or after the cryptographic processor.

This will cause the processing time of cryptographic processor to vary, and the insertion of preprocessing and postprocessing can make the start time and end time of cryptographic processor variable, thereby further increasing the resistance against power analysis.

Next, a second variation will be described. While the cryptographic processing apparatus of the above described each embodiment includes a random number generation circuit 18, a cryptographic processing apparatus of the present variation includes a probability adjustment section which adjusts the probability of execution of normal operation that is determined by a random number RN generated by a random number generation circuit.

In the random number generation circuit of the cryptographic processing apparatus of the above described each embodiment, the probability of reverse operation processing being inserted will be 50%. For example, when it is supposed that random numbers are generated so that the probability of occurrence of each of [1] and [0] is 50% based on the random numbers, since reverse operation will be randomly inserted during cryptographic processor, there is a risk that the cryptographic processor does not end within a processing time required for the cryptographic processing apparatus.

Accordingly, in the present second variation, configuration is made such that the probability of execution of cryptographic processor is higher than the probability of execution of reverse operation so that execution time of the cryptographic processing apparatus is kept within a predetermined time period.

For that purpose, a probability adjustment section for adjusting the probability of occurrence of the random number generated by a random number generation circuit is provided in the random number generation circuit or separately outside the random number generation circuit.

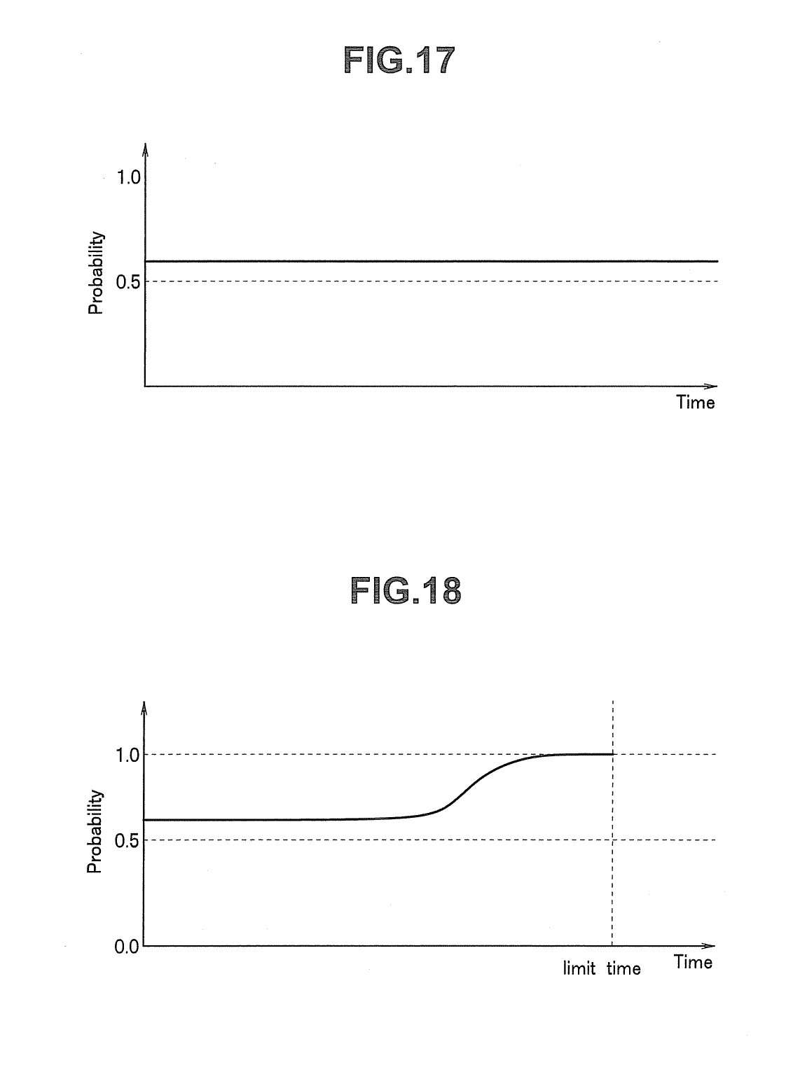

FIGS. 17 to 19 are diagrams to show the change of the probability of execution of cryptographic processor based on a probability adjustment signal Pc from a probability adjustment section 18a. FIG. 20 is a diagram to show the configuration of a cryptographic processing apparatus 1D relating to the second variation. In FIG. 20, the same components as those of FIG. 1 are given the same reference characters, thereby omitting the description thereof. In FIG. 20, the probability adjustment section 18a is connected to the random number generation circuit 18 to provide a probability adjustment signal Pc. The probability of occurrence of reverse operation of a random number Rn generated by the random number generation circuit 18 or the probability of execution of cryptographic processor is changed based on the probability adjustment signal Pc from the probability adjustment section 18a. In other words, the probability adjustment section 18a adjusts the probabilities of execution of the first operation (reverse operation) and the second operation (normal operation corresponding to the reverse operation) which are determined by the random number RN generated by the random number generation circuit 18.

FIG. 17 shows that the probability of execution of cryptographic processor based on the probability adjustment signal Pc is a constant value which is higher by a predetermined amount than the value 0.5 shown by a dotted line. It is supposed that cryptographic processor is executed, or reverse operation (and normal operation corresponding to the reverse operation) is executed according to a predetermined value determined by a random value RN. In that occasion, it is further supposed that for example, execution of cryptographic operation is instructed when the predetermined value is “1”, and insertion of reverse operation is instructed when the predetermined value is “0”. In this occasion, making the probability of occurrence of the predetermined value “1” higher than 0.5 will make it more likely that the cryptographic processor of the cryptographic processing apparatus is ended within a predetermined time period since the probability of execution of cryptographic processor becomes higher than 0.5. The probability of occurrence of the predetermined value “1” is set to a higher value as the required processing time of cryptographic processor decreases. Using such a method makes the cryptographic processing apparatus becomes more resistant to power analysis since the ending time thereof changes probabilistically.

FIG. 18 shows that the probability of execution of cryptographic processor based on the probability adjustment signal Pc is higher by a predetermined amount than the value 0.5 shown by a dotted line, and becomes higher as the time approaches a predetermined limit time. Particularly, the probability of execution of cryptographic processor is 1.0 in a certain period immediately before the limit time. Since, in this way, the probability of execution of cryptographic processor becomes higher as the time approaches a predetermined limit time and further becomes 1.0 immediately before the limit time, it is possible to certainly end the cryptographic processor of the cryptographic processing apparatus within a predetermined time period.

In this way, when a limit value is set in the processing time of the cryptographic processing apparatus, since making the probability of occurrence increase as the time approaches the limit time will result in an increase in the probability of occurrence of cryptographic processor as the time approaches the limit time, it becomes possible to make the end time close to the limit time. Further, making the probability of occurrence be 1.0 when the time reaches a limit by which the number of remaining steps can be processed within the limit time, it becomes possible to make the processing time stay within the limit time.

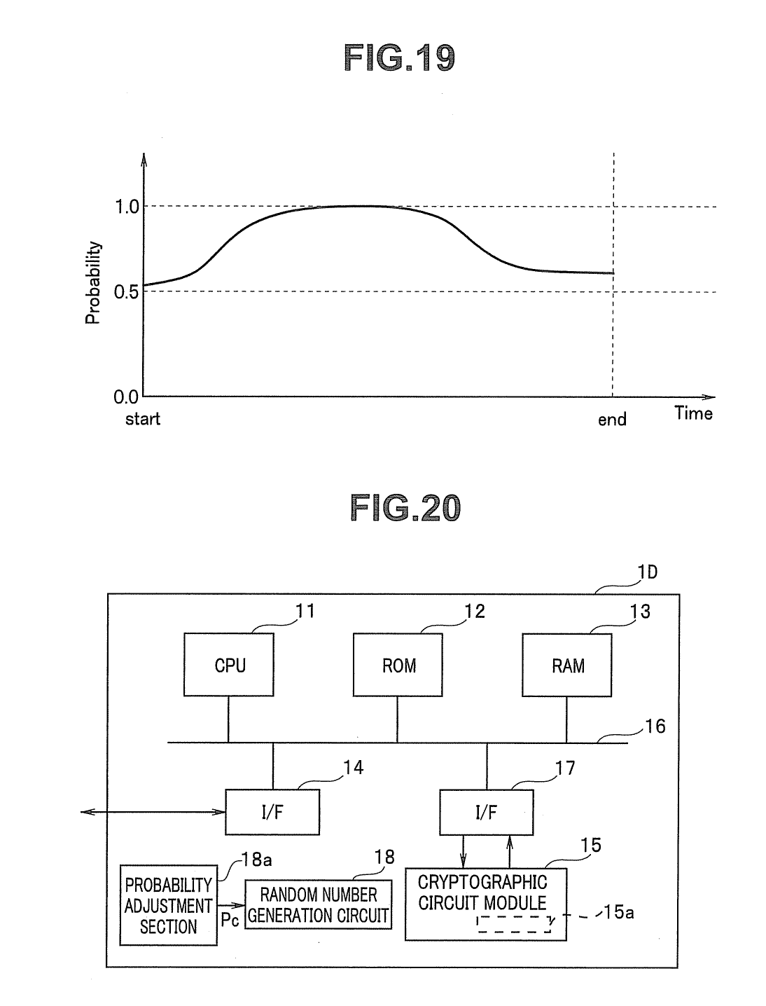

FIG. 19 shows that the probability of execution of cryptographic processor based on the probability adjustment signal Pc is higher by a predetermined amount than the value 0.5 shown by a dotted line, and is higher in an interim period between a first half and a second half of cryptographic processor. Particularly, the probability of execution of cryptographic processor is 1.0 in the interim period. Since the probability of execution of cryptographic processor is higher in the interim period, it is possible to certainly end the cryptographic processor of the cryptographic processing apparatus within a predetermined time period, and further since the probability that reverse operation processing is executed is relatively high in the first half and the second half, it is possible to increase the resistance against power analysis.

To be specific, at the start of cryptographic processor and at the end of operation, the probability of execution of cryptographic processor is kept low, and is larger than 0.5 in other times. Generally, in a power analysis against cryptographic processor, the start and the end of cryptographic processor are targets of attack. Therefore, by making the probability of execution of cryptographic processor closer to 0.5 at the start and the end thereof, it becomes possible to increase the probability of occurrence of reverse operation at the start and the end of the processing, thereby obscuring when the cryptographic processor is started and ended.

As so far described, the probability adjustment section 18a adjusts the probability of execution of cryptographic processor or the probability of execution of reverse operation (and normal operation corresponding to the reverse operation) such that the probability of execution of encryption operation is higher than the probability of execution of decryption operation which is reverse operation (and normal operation corresponding to the reverse operation) when the cryptographic processor to be executed in a cryptographic operation processing section is encryption operation, and such that the probability of execution of decryption operation is higher than the probability of execution of encryption operation which is reverse operation (and normal operation corresponding to the reverse operation) when the cryptographic processor is decryption operation, so that the processing time of cryptographic processor will end within a predetermined time.

Next, a third variation will be described. According to the above described each embodiment and each variation, by inserting reverse operation processing into cryptographic processor, it is possible to realize a cryptographic processing apparatus which has resistance against power analysis attack even without using dummy operation. Therefore, even without providing a conventional register circuit for dummy operation, the cryptographic processing time varies thereby making it possible to provide resistance against power analysis.

However, there is a case in which enough room for equipping a register circuit is available on a chip and therefore the circuit scale is not an issue.

In such a case, providing a register circuit for dummy operation, and adding dummy operation to cryptographic processor relating to the above described each embodiment and each variation will make it possible to further increase the resistance against power analysis.

In that case, as shown by a dotted line in FIG. 20, a register circuit 15a is provided in a cryptographic circuit module 15. Then, insertion of reverse operation (and normal operation corresponding to the reverse operation) and insertion of dummy operation are performed based on a random number RN.

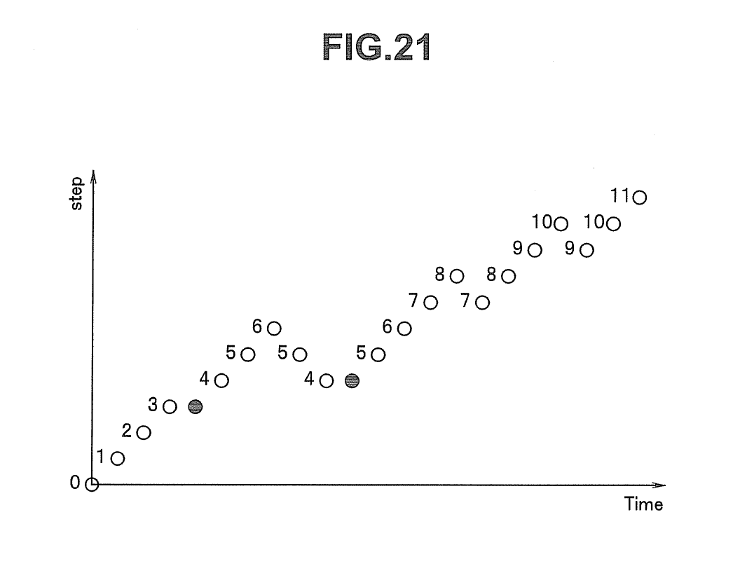

FIG. 21 is a graph to show the change of step with respect to time when reverse operation and dummy operation are combined. As shown in FIG. 21, since reverse operation and dummy operation are randomly inserted, it is possible to further increase the resistance against power analysis. In FIG. 21, as with FIG. 6, the horizontal axis indicates time, the vertical axis indicates step, and a rightward ascent indicates normal operation, a rightward descent indicates reverse operation, and a black circle indicates that dummy operation has been performed.

It is noted that although in the above described embodiments and each variation, description has been made taking an IC card as an example of each cryptographic processing apparatus, which may be other equipment.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. A cryptographic processing apparatus, comprising:
a cryptographic operation processing section that can execute cryptographic processor of encryption operation and decryption operation; and
a control section that controls execution of the cryptographic operation processing section such that a first operation for converting a first value, which is input data to be subjected to the cryptographic processor, or intermediate data during the cryptographic processor, into a second value, and a second operation for converting the second value into the first value are performed successively at least one time.

2. The cryptographic processing apparatus according to claim 1, wherein
the first operation is the decryption operation which is reverse operation of the encryption operation when the cryptographic processor to be executed in the cryptographic operation processing section is the encryption operation, and is the encryption operation which is reverse operation of the decryption operation when the cryptographic processor is the decryption operation, and
the second operation is the encryption operation when the cryptographic processor to be executed in the cryptographic operation processing section is the encryption operation, and is the decryption operation when the cryptographic processor is the decryption operation.

3. The cryptographic processing apparatus according to claim 2, further comprising
a random number generation section, wherein
the control section determines positions of the first and second operation to be inserted into the encryption operation or the decryption operation which is executed a multiple number of times in the cryptographic processor, based on a random number generated in the random number generation section.

4. The cryptographic processing apparatus according to claim 2, wherein
the control section controls execution of the cryptographic operation processing section such that when the cryptographic processor to be executed in the cryptographic operation processing section is the encryption operation, the decryption operation which is the reverse operation is executed successively a multiple number of times, and thereafter the encryption operation is executed successively a same number of times as the multiple number of times, and when the cryptographic processor to be executed in the cryptographic operation processing section is the decryption operation, the encryption operation which is the reverse operation is executed successively a multiple number of times, and thereafter the decryption operation is executed successively a same number of times as the multiple number of times.

5. The cryptographic processing apparatus according to claim 4, wherein
the control section determines the multiple number of times based on the random number.

6. The cryptographic processing apparatus according to claim 3, further comprising
a probability adjustment section that adjusts an execution probability of the first and second operation which are determined by a random number generated by the random number generation section.

7. The cryptographic processing apparatus according to claim 6, wherein
the probability adjustment section adjusts a probability of occurrence of the predetermined value so that processing time of the cryptographic processor falls within a predetermined time period, such that an execution probability of the encryption operation is higher than an execution probability of the decryption operation which is the reverse operation when the cryptographic processor to be executed in the cryptographic operation processing section is the encryption operation, and such that an execution probability of the decryption operation is higher than an execution probability of the encryption operation which is the reverse operation when the cryptographic processor is the decryption operation.

8. The cryptographic processing apparatus according to claim 1, wherein
the control section compares the first value with a value of an operation result of the second operation, and when, based on a result of the comparison, the first value is inconsistent with the value of the operation result, halts execution of the cryptographic processor in the cryptographic operation processing section.

9. The cryptographic processing apparatus according to claim 8, further comprising:
a first register that retains the first value;
a second register that retains a value of an operation result of the second operation; and
a comparator that compares the first value of the first register with a value of an operation result of the second operation of the second register, wherein
the comparator outputs a predetermined signal if the first value is inconsistent with the value of the operation result, and
execution of the cryptographic processor is halted based on the predetermined signal.

10. The cryptographic processing apparatus according to claim 2, wherein
the cryptographic processor is a cryptographic processor of AES or DES,
the control section includes:
a round control section that controls a round to be executed in the AES or the DES; and
a round control counter that retains a round to be executed by the round control section, and
the control section causes the encryption operation and the decryption operation in the cryptographic operation processing section to be executed by making the round control section increase or decrease a count value of the round control counter.

11. The cryptographic processing apparatus according to claim 2, wherein
the control section inserts the first operation and the second operation, which are performed successively the at least one time, at least one of before and after the cryptographic processor.

12. The cryptographic processing apparatus according to claim 1, wherein
the control section inserts dummy operation processing during cryptographic processor to be executed in the cryptographic operation processing section.

13. An IC card, comprising:
a cryptographic processing apparatus, wherein the cryptographic processing apparatus comprises:
a cryptographic operation processing section that can execute cryptographic processor of encryption operation and decryption operation; and
a control section that controls the execution of the cryptographic operation processing section such that a first operation for converting a first value, which is input data to be subjected to the cryptographic processor or intermediate data during the cryptographic processor, into a second value, and a second operation for converting the second value into the first value, are performed successively at least one time.

14. A cryptographic processing apparatus, comprising:
a cryptographic operation processing section that can execute cryptographic processor of encryption operation and decryption operation of DES or AES;
a random number generation section; and
a control section that determines position of a first and a second operation to be inserted into the encryption operation or the decryption operation which is executed a multiple number of times in the cryptographic processor based on a random number generated in the random number generation section such that a first operation for converting a first value, which is input data to be subjected to the cryptographic processor, or intermediate data during the cryptographic processor, into a second value, and a second operation for converting the second value into the first value are performed successively at least one time, to control execution of the cryptographic operation processing section, wherein
the first operation is the decryption operation which is reverse operation of the encryption operation when the cryptographic processor to be executed in the cryptographic operation processing section is the encryption operation, and is the encryption operation which is reverse operation of the decryption operation when the cryptographic processor is the decryption operation, and
the second operation is the encryption operation when the cryptographic processor to be executed in the cryptographic operation processing section is the encryption operation, and is the decryption operation when the cryptographic processor is the decryption operation.

15. The cryptographic processing apparatus according to claim 14, wherein
the control section compares the first value with a value of an operation result of the second operation, and when, based on a result of the comparison, the first value is inconsistent with the value of the operation result, halts execution of the cryptographic processor in the cryptographic operation processing section.

16. The cryptographic processing apparatus according to claim 15, further comprising:
a first register that retains the first value;
a second register that retains a value of an operation result of the second operation; and
a comparator that compares the first value of the first register with a value of an operation result of the second operation of the second register, wherein
the comparator outputs a predetermined signal if the first value is inconsistent with the value of the operation result, and
execution of the cryptographic processor is halted based on the predetermined signal.

17. The cryptographic processing apparatus according to claim 14, wherein
the control section includes:
a round control section that controls a round to be executed in the AES or the DES; and
a round control counter that retains a round to be executed by the round control section, and
the control section causes the encryption operation and the decryption operation in the cryptographic operation processing section to be executed by making the round control section increase or decrease a count value of the round control counter.

18. The cryptographic processing apparatus according to claim 14, wherein
the control section inserts the first operation and the second operation, which are performed successively the at least one time, at least one of before and after the cryptographic processor.

19. The cryptographic processing apparatus according to claim 14, wherein
the control section inserts dummy operation processing during cryptographic processor to be executed in the cryptographic operation processing section.

20. The IC card according to claim 13, further comprising
a random number generation section, wherein
the cryptographic processor is a cryptographic processor of AES or DES,
the control section determines positions of the first and the second operation to be inserted into the encryption operation or the decryption operation which is executed a multiple number of times in the cryptographic processor, based on a random number generated in the random number generation section,
the first operation is the decryption operation which is reverse operation of the encryption operation when the cryptographic processor to be executed in the cryptographic operation processing section is the encryption operation, and is the encryption operation which is reverse operation of the decryption operation when the cryptographic processor is the decryption operation, and
the second operation is the encryption operation when the cryptographic processor to be executed in the cryptographic operation processing section is the encryption operation, and is the decryption operation when the cryptographic processor is the decryption operation.
